(19) United States
(12) Patent Application Publication
(10) Pub. No.: US 2013/0218621 A1
(43) Pub. Date: Aug. 22, 2013

(54) METHOD AND SYSTEM FOR MANAGING DEADLINE SENSITIVE TASKS

(71) Applicants: THOMAS A. JACKSON, Webster, NY (US); Vinayak Kumbhakern, Webster, NY (US); Marsha L. Leech, Rochester, NY (US)

(72) Inventors: THOMAS A. JACKSON, Webster, NY (US); Vinayak Kumbhakern, Webster, NY (US); Marsha L. Leech, Rochester, NY (US)

(73) Assignee: Xerox Corporation, Norwalk, CT (US)

(21) Appl. No.: 13/402,589

(22) Filed: Feb. 22, 2012

(51) Int. Cl. G06Q 10/06

(52) U.S. Cl. 705/7.15

(57) ABSTRACT

A method, non-transitory computer readable medium and apparatus for managing deadline sensitive tasks are disclosed. For example, the method receives a list of tasks assigned to an employee, monitors a progress of each one of the tasks, determines a critical deadline associated with one of the tasks in the list is reached and removes one or more non-essential permissions of the employee until the one of the tasks in the list is completed.

The present disclosure relates generally to managing progress of employees' tasks and, more particularly, to a method, a non-transitory computer readable medium, and an apparatus for managing deadline sensitive tasks.

### BACKGROUND

Currently, existing task and event scheduling tools manage tasks by providing a reminder feature. However, once the reminder is received these tools also allow the user to dismiss or reschedule the task or event. Even if a deadline is approaching or passed, the user may simply dismiss or snooze the task or event. As a result, the reminder may never show up again and the task or event may never be completed by the user. Consequently, the current task and event scheduling tools are ineffective at managing deadline sensitive tasks.

### SUMMARY

According to aspects illustrated herein, there are provided a method, a non-transitory computer readable medium and an apparatus for managing deadline sensitive tasks. One disclosed feature of the embodiments is a method that receives a list of tasks assigned to an employee, monitors a progress of each one of the tasks, determines a critical deadline associated with one of the tasks in the list is reached and removes one or more non-essential permissions of the employee until the one of the tasks in the list is completed.

Another disclosed feature of the embodiments is a non-transitory computer-readable medium having stored thereon a plurality of instructions, the plurality of instructions including instructions which, when executed by a processor, cause the processor to perform a method that receives a list of tasks assigned to an employee, monitors a progress of each one of the tasks, determines a critical deadline associated with one of the tasks in the list is reached and removes one or more non-essential permissions of the employee until the one of the tasks in the list is completed.

Another disclosed feature of the embodiments is an apparatus for managing deadline sensitive tasks comprising a processor and a computer readable medium having stored thereon a plurality of instructions, including instructions which, when executed by the processor, cause the processor to perform a method that receives a list of tasks assigned to an employee, monitors a progress of each one of the tasks, determines a critical deadline associated with one of the tasks in the list is reached and removes one or more non-essential permissions of the employee until the one of the tasks in the list is completed.

### BRIEF DESCRIPTION OF THE DRAWINGS

The teaching of the present disclosure can be readily understood by considering the following detailed description in conjunction with the accompanying drawings, in which:

FIG. 1 illustrates one example of a communications network of the present disclosure;

FIG. 2 illustrates an example flowchart of one embodiment of a method for managing deadline sensitive tasks;

FIG. 3 illustrates an example flowchart of one embodiment of a method for modifying a critical deadline; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, a non-transitory computer readable medium and an apparatus for managing deadline sensitive tasks. As discussed above, currently existing task and event scheduling tools manage tasks by providing a reminder feature. However, once the reminder is received, these tools also allow the user to dismiss or reschedule the task or event. Even if a deadline is approaching or passed, the user may simply dismiss or snooze the task or event. As a result, the reminder may never show up again and the task or event may never be completed by the user. Consequently, the current task and event scheduling tools are ineffective at managing deadline sensitive tasks.

In one embodiment of the present disclosure, an automated method and system for managing deadline sensitive tasks is provided. In one embodiment, as critical deadlines are reached non-essential permissions of an employee may be removed to force the employee to complete the required task. The non-essential permissions may be restored once the task is completed.

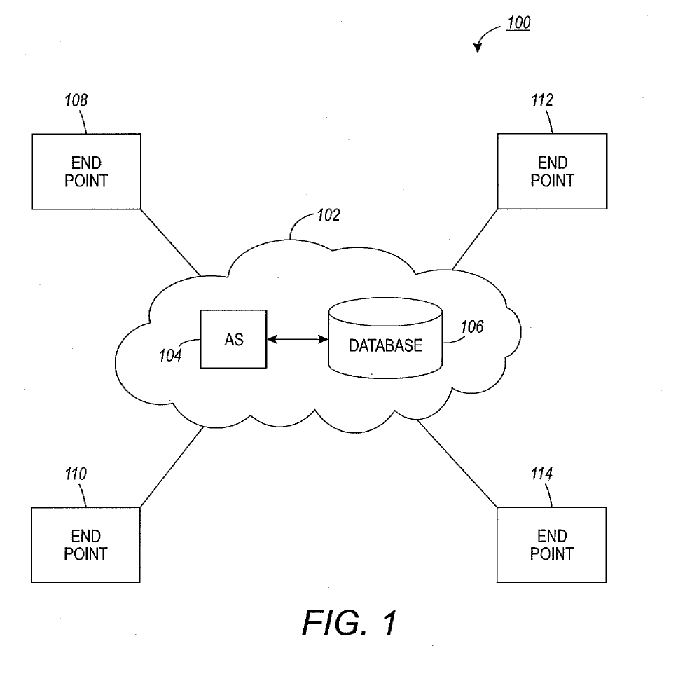

To better understand the present disclosure, FIG. 1 illustrates an example of a communications network 100. In one embodiment, the communications network 100 includes an Internet Protocol (IP) network 102. The IP network 102 may be, for example, the Internet, a service provider network, a local area network (LAN) within a company location, an access network, a core network and the like.

In one embodiment, the IP network 102 may include a general purpose application server (AS) 104 and a database (DB) 106. In one embodiment, the AS 104 may be configured to execute the methods and algorithms described herein and discussed in further detail below. It should be noted that although only a single AS 104 is illustrated in FIG. 1, that any number of application servers may be deployed.

In one embodiment, the DB 106 may store various information such as a list of tasks associated with each one of a plurality of employees and critical deadlines associated with each one of the tasks. The DB 106 may also store for example a list of non-essential permissions and an associated permission status (e.g., allow or deny) for each one of the plurality of employees. It should be noted that the above examples are not intended to be limiting and that other types of information may be stored in the DB 106.

It should be noted that although only a single DB 106 is illustrated in FIG. 1 the present disclosure is not so limited. For example, a plurality of databases may be deployed for one or more of the information described above that is stored.

In one embodiment, the communications network 100 may include one or more endpoint devices 108, 110, 112 and 114. The one or more endpoint devices 108, 110, 112 and 114 may be any type of endpoint device capable of communicating with the IP network 102. In one embodiment, the endpoint devices 108, 110, 112 and 114 may be a personal computer, a lap-top computer, a tablet device, a smartphone, a netbook, and the like. Although only four endpoint devices 108, 110, 112 and 114 are illustrated in FIG. 1, it should be noted that any number of endpoint devices may be deployed.

It should be noted that the network 100 has been simplified. For example, the network 100 may include other network elements (not shown) such as border elements, routers, switches, policy servers, security devices, a content distribution network (CON) and the like. In addition, the network 100 may include additional networks between the endpoints (e.g., the endpoints 108, 110, 112 and 114) and the IP network 102 such as different access networks (e.g., wireless access networks, WiFi networks, cellular networks, cable networks, and the like) to reach the IP network 102.

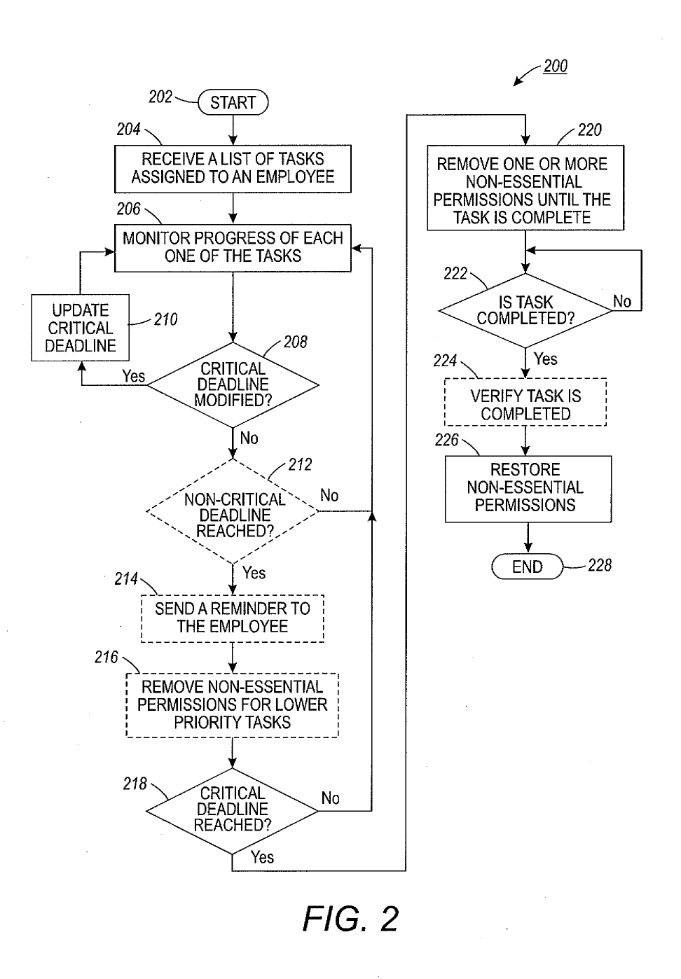

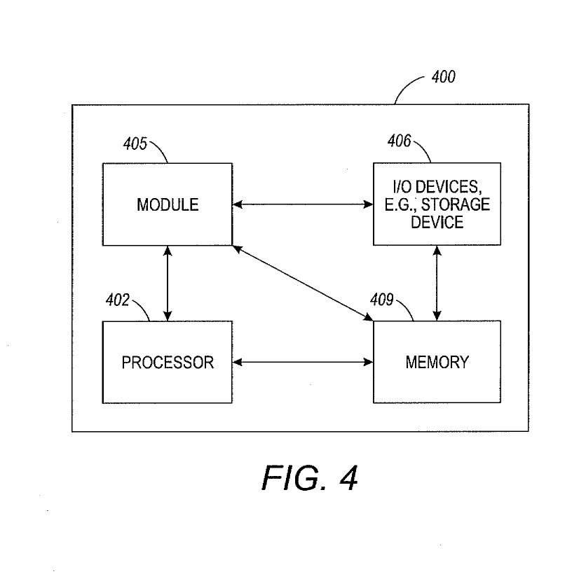

FIG. 2 illustrates a flowchart of a method 200 for managing deadline sensitive tasks. In one embodiment, the method 200 may be performed by the AS 104, by an endpoint 108, 110, 112 or 114, by a combination of both the AS 104 and one or more of the endpoints 108, 110, 112 or 114 or a general purpose computer as illustrated in FIG. 4 and discussed below.

In one embodiment, the method 200 may be executed in a web application environment running on either the AS 104 or one of the endpoints 108, 110, 112 or 114. For example, an employee may log into a web page hosted by the AS 104 via his or her endpoint device.

The method 200 begins at step 202. At step 204 the method 200 receives a list of tasks assigned to an employee. For example, an employee may log into his or her endpoint when he or she arrives to work. If the method 200 is executed by the AS 104, the AS 104 may receive the list of tasks for the employee from the DB 106. If the method 200 is executed by the endpoint, the endpoint may receive the list of tasks for the employee from the AS 104. In one embodiment, the tasks may be prioritized in the list from most critical to least critical, or vice versa. Each one of the tasks may be associated with a critical deadline.

In one embodiment, the critical deadline may be calculated based upon an estimated completion time for the task, a priority of the task, a complexity of the task, and other relevant factors. In one embodiment, the critical deadline may be defined as the latest date and time that a task must be started without exceeding the actual deadline for the task, assuming that the estimated completion time for the task is accurate. For example, if a task is estimated to take 40 hours to complete, assuming an employee works 8 hour shifts, a critical deadline may be set 5 working days before the actual deadline.

In one embodiment, a list of tasks may be assigned to each one of a plurality of employees. In one embodiment, the list of tasks and which list each employee is assigned to may be stored in the DB 106. In one embodiment, the list of tasks assigned to an employee may be stored locally in memory on the employee's endpoint device (e.g., the endpoint device 108).

At step 206, the method 200 monitors a progress of each one of the tasks in the list. For example, the method 200 may determine if the tasks have been started and if the tasks have been completed. To illustrate, when an employee begins a task, the task on the list may be moved from an “open” status to an “in progress” status.

Once the task is completed, the monitoring may include determining if an indication that the task is completed is received from the employee. For example, the list of tasks may have a box next to each one of the tasks that may be “checked” electronically by the employee. Once the task is “checked”, an indication that the task has been completed may be transmitted. The monitoring may be performed on a continuous basis or on a periodic basis (e.g., once every hour, once every day, once every week and so forth).

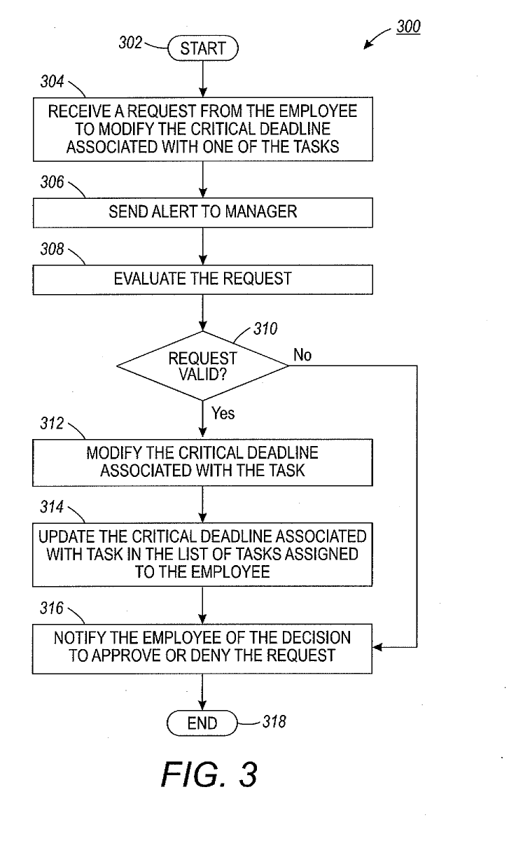

At step 208, the method 200 determines if a critical deadline for a particular task has been modified. How the critical deadline may be modified is discussed in further detail below with respect to FIG. 3.

If the critical deadline is modified, the method 200 proceeds to step 210. At step 210, the method 200 updates the critical deadline of the task that has had its respective critical deadline modified. The method 200 then returns back to step 206 to monitor a progress of each one of the tasks in the list.

If the critical deadline is not modified at step 208, the method 200 proceeds to optional step 212. At step 212, the method 200 may determine if a non-critical deadline has been reached. In one embodiment, the non-critical deadline may be a predefined time period before the critical deadline (e.g., two weeks, a month and the like). If the non-critical deadline has not been reached, the method 200 returns back to step 206 to monitor a progress of each one of the tasks in the list.

However, if the non-critical deadline has been reached, the method 200 may proceed to optional step 214. At step 214, the method 200 sends a reminder to the employee. In one embodiment, the reminder may be sent as a text message, an automated phone call, an email message, and the like.

At step 216, the method 200 may optionally remove non-essential permissions for lower priority tasks. For example, if the list of tasks is prioritized as noted above, the non-essential permissions for the lower priority tasks may be removed to help focus the employee on completing the most important or highest priority task first. In one embodiment, non-essential permissions may be defined as permission to access any program that is not required or needed to complete a particular task.

To illustrate by example, an employee may have a highest priority task that requires a spreadsheet program and lower priority tasks that require a word processing program and a database program. If the non-critical deadline is reached and the highest priority task only requires the spreadsheet program, the method 200 may remove permissions to access the word processing program and the database program. In other words, the word processing program and the database program would be considered “non-essential” and permissions to access these programs would be temporarily removed until the highest priority task is completed.

How the non-essential permissions are removed may depend on how the method 200 is implemented. For example, if the AS 104 is executing the method 200 and the software is located centrally on a server, a table including permissions to access the software for each one of the employees may be stored in the DB 106. When the non-essential permissions are removed for an employee, the permission status for the employee may be changed for the appropriate software from “allow” to “deny” or some other similar demarcation. As a result, using the above example if the employee attempts to access the word processing software, the employee may be denied access and the software would not launch.

In another example, if the endpoint of the employee is executing the method 200 (e.g., the endpoint 108), the endpoint may “lock” the executable file for the software, hide one or more directory folders associated with the software that include the executable file or uninstall or delete the executable file from the employee's endpoint device.

In one embodiment, removing non-essential permissions may include removing non-essential permissions to one or more select features within a program. For example, to help focus the employee on completing a high priority task, the outbound email feature of an email program may be locked or removed. As a result, the employee may not be able to write outgoing emails. However, the employee could still receive incoming email. In another embodiment, the employee may only be allowed to access the Intranet using a web browser program to obtain company related documents, but may be denied access to the Internet to get to external web sites using the web browser program. The above are only a few examples and should not be considered limiting.

In one embodiment, the non-essential permissions may be automatically removed by the AS 104 or the endpoint. Alternatively, a network administrator may manually remove the non-essential permissions.

In one embodiment, after the non-essential permissions are removed, a notification may be sent to the employee indicating which non-essential permissions have been removed and which tasks must be completed. For example, the notification may include a pop-up window on the employee's endpoint device, an instant message, an email message, an automated telephone call, and the like.

At step 218, the method 200 determines if a critical deadline is reached. If the critical deadline is not reached, the method 200 returns back to step 206 to monitor a progress of each one of the tasks in the list.

However, if the critical deadline is reached, the method 200 proceeds to step 220. At step 220, the method 200 removes one or more non-essential permissions until the task is completed. In one embodiment, all non-essential permissions may be removed. In another embodiment, if some of the non-essential permissions were removed at the optional step 216, any remaining non-essential permissions may be removed. The non-essential permissions may be removed as discussed above.

At step 222, the method 200 determines if the task is completed. If the task is not completed, the method 200 continues to loop back to step 222.

At step 222, if the task is completed, the method 200 proceeds to optional step 224. In one embodiment at step 224, the method 200 may verify that the task is completed. For example, a notification may be sent to inform a manager that the employee has indicated that the task that had the critical date reached is completed and require the manager to verify that the task was actually completed.

At step 226, the method 200 restores all non-essential permissions that were removed at the optional step 216 and/or step 220. For example, the status for the appropriate software may be changed from “deny” to “allow”, the executable files may be re-installed, the executable files may be unlocked or directory files storing the executable files may be restored or unhidden. The method 200 ends at step 228.

FIG. 3 illustrates a flowchart of a method 300 for modifying a critical deadline described in step 208 in FIG. 2 above. In one embodiment, the method 300 may be performed by the AS 104, by an endpoint 108, 110, 112 or 114, by a combination of both the AS 104 and one or more of the endpoints 108, 110, 112 or 114 or a general purpose computer as illustrated in FIG. 4 and discussed below.

In one embodiment, the method 300 may be executed in a web page environment running on either the AS 104 or one of the endpoints 108, 110, 112 or 114. For example, an employee may log into a web page hosted by the AS 104 via his or her endpoint device.

The method 300 begins at step 302. At step 304, the method 300 receives a request from the employee to modify the critical deadline associated with one of the tasks. In one embodiment, the request may include one or more reasons for the request, e.g., workload, unexpected delay, recently added higher priority task, and the like.

At step 306, the method 300 sends an alert to a manager of the employee. In one embodiment, the alert may be a text message, an automated phone call, an email message, an instant message and the like.

At step 308, the method 300 evaluates the request. In one embodiment, the evaluation may be automated and the manager may simply need to approve the request. For example, predefined reasons for approving a request to modify the critical deadline may be stored, e.g., in the DB 106. In one embodiment, predefined reasons may include, for example, receiving a higher priority task, having a number of tasks greater than a predefined threshold (i.e., a high workload), an unexpected delay, a re-assignment, and the like. As a result, the reasons included in the request may be matched against the predefined reasons for approving the request. In another embodiment, the request may be evaluated manually by the manager.

At step 310, the method 300 determines if the request is valid. If the request is not valid, the method 300 proceeds to step 316 where the method 300 notifies the employee of the decision to approve or deny the request. For example, if the request is not valid at step 310, the method 300 at step 316 would notify the employee that the request was denied. The request may be sent automatically via an email, a text message, an automated phone call, or using any other type of communication method.

However, if the request is valid, the method 300 proceeds to step 312. At step 312, the critical deadline associated with the task is modified. In one embodiment, the new critical deadline may be calculated based upon the present date and the estimated time of completion for the task, i.e., the critical deadline is pushed out to a later time.

At step 314, the method 300 updates the critical deadline associated with the task in the list of tasks assigned to the employee. The method 300 then proceeds to step 316. At step 316, the method 300 notifies the employee of the decision to approve or deny the request. For example, if the request is valid at step 310, the method 300 at step 316 would notify the employee that the request was accepted. The request may be sent automatically via an email, a text message, an automated phone call, or using any other type of communication method.

The method 300 then proceeds to step 318. At step 318, the method 300 ends.

It should be noted that although not explicitly specified, one or more steps or blocks of the methods 200 and 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in FIGS. 2 and 3 that recite a determining operation, or involve a decision, do not necessarily require that both branches of the determining operation be practiced. In other words, one of the branches of the determining operation can be deemed as an optional step.

FIG. 4 depicts a high-level block diagram of a general-purpose computer suitable for use in performing the functions described herein. As depicted in FIG. 4, the system 400 comprises a hardware processor element 402 (e.g., a CPU), a memory 404, e.g., random access memory (RAM) and/or read only memory (ROM), a module 405 for managing deadline sensitive tasks, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps of the above disclosed method. In one embodiment, the present module or process 405 for managing deadline sensitive tasks can be loaded into memory 404 and executed by processor 402 to implement the functions as discussed above. As such, the present method or process 405 for managing deadline sensitive tasks (including associated data structures) of the present disclosure can be stored on a non-transitory (e.g., tangible or physical) computer readable storage medium, e.g., RAM memory, magnetic or optical drive or diskette and the like. For example, the processor 402 can be programmed or configured with instructions (e.g., computer readable instructions) to perform the steps of method 300.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for managing deadline sensitive tasks, comprising:
receiving a list of tasks assigned to an employee;
monitoring a progress of each one of the tasks;
determining a critical deadline associated with one of the tasks in the list is reached; and
removing one or more non-essential permissions of the employee until the one of the tasks in the list is completed.

2. The method of claim 1, further comprising:
determining a non-critical deadline associated with the one of the tasks in the list is reached; and
sending a reminder to the employee to complete the one of the tasks in the list.

3. The method of claim 1, further comprising:
receiving a request from the employee to modify the critical deadline associated with the one of the tasks;
modifying the critical deadline associated with the one of the tasks; and
updating the critical deadline associated with the one of the tasks in the list.

4. The method of claim 1, wherein the monitoring comprises determining if the employee has indicated that a task is completed.

5. The method of claim 1, wherein the removing the one or more non-essential permissions comprises at least one of: deleting non-essential executable files from a workstation of the employee, hiding non-essential executable files on the workstation of the employee, or locking non-essential executable files on the workstation of the employee.

6. The method of claim 1, wherein the removing the one or more non-essential permissions comprises changing a permission status of the employee for an access right to one or more programs.

7. The method of claim 1, wherein the removing the one or more non-essential permissions comprises locking one or more features of a program.

8. The method of claim 1, further comprising:
prioritizing each one of the tasks in the list;
determining a critical deadline associated with a highest priority task on the list is reached; and
removing one or more permissions associated with lower priority tasks on the list until the highest priority task is completed.

9. The method of claim 1, further comprising:
verifying that the employee has completed the one of the tasks in the list that has reached the critical deadline; and
restoring the one or more non-essential permissions of the employee.

10. A non-transitory computer-readable medium having stored thereon a plurality of instructions, the plurality of instructions including instructions which, when executed by a processor, cause the processor to perform a method for managing deadline sensitive tasks, comprising:
receiving a list of tasks assigned to an employee;
monitoring a progress of each one of the tasks;
determining a critical deadline associated with one of the tasks in the list is reached; and
removing one or more non-essential permissions of the employee until the one of the tasks in the list is completed.

11. The non-transitory computer-readable medium of claim 10, further comprising:
determining a non-critical deadline associated with the one of the tasks in the list is reached; and
sending a reminder to the employee to complete the one of the tasks in the list.

12. The non-transitory computer-readable medium of claim 10, further comprising:
receiving a request from the employee to modify the critical deadline associated with the one of the tasks;
modifying the critical deadline associated with the one of the tasks; and
updating the critical deadline associated with the one of the tasks in the list.

13. The non-transitory computer-readable medium of claim 10, wherein the monitoring comprises determining if the employee has indicated that a task is completed.

14. The non-transitory computer-readable medium of claim 10, wherein the removing the one or more non-essential permissions comprises at least one of: deleting non-essential executable files from a workstation of the employee, hiding non-essential executable files on the workstation of the employee, or locking non-essential executable files on the workstation of the employee.

15. The non-transitory computer-readable medium of claim 10, wherein the removing the one or more non-essential permissions comprises changing a permission status of the employee for an access right to one or more programs.

16. The non-transitory computer-readable medium of claim 10, wherein the removing the one or more non-essential permissions comprises locking one or more features of a program.

17. The non-transitory computer-readable medium of claim 10, further comprising:
prioritizing each one of the tasks in the list;
determining a critical deadline associated with a highest priority task on the list is reached; and
removing one or more permissions associated with lower priority tasks on the list until the highest priority task is completed.

18. The non-transitory computer-readable medium of claim 10, further comprising:
verifying that the employee has completed the one of the tasks in the list that has reached the critical deadline; and
restoring the one or more non-essential permissions of the employee.

19. A method managing deadline sensitive tasks, comprising:
receiving a list of tasks assigned to an employee, wherein the task are prioritized and each one of the tasks is associated with a respective critical deadline and a respective non-critical deadline;
monitoring a progress of each one of the tasks;
determining if the respective non-critical deadline associated with one of the tasks is reached;
if the respective non-critical deadline associated with the one of the tasks is reached, reminding the employee to complete a highest priority task and removing a subset of non-essential permissions of the employee;
determining if the respective critical deadline associated with the one of the tasks in the list is reached; and
if the respective critical deadline associated with the one of the tasks in the list is reached, removing all remaining non-essential permissions of the employee until the one of the tasks in the list is completed.

20. The method of claim 19, further comprising:
receiving a request from the employee to modify the respective critical deadline associated with the one of the tasks;
modifying the respective critical deadline associated with the one of the tasks; and
updating the respective critical deadline associated with the one of the tasks in the list.
